(19) United States
(12) Patent Application Publication
(10) Pub. No.: US 2009/0160594 A1
(43) Pub. Date: Jun. 25, 2009

(54) COILED COMPONENT AND ELECTRONIC APPARATUS

(75) Inventor: Takahiro Sakaguchi, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/245,090

(22) Filed: Oct. 3, 2008

(30) Foreign Application Priority Data
Dec. 20, 2007 (JP) 2007-329069

(51) Int. Cl. H01F 27/29

(52) U.S. Cl. 336/192

(57) ABSTRACT

According to one embodiment, a coiled component includes a conductor wire including a portion coiled around a core and an end portion out of the core, a lead including a first end portion and a second end portion to which the end portion of the conductor wire is connected, and a protrusion section protruding at a position outwardly shifted from the second end portion of the lead as seen from the core. The conductor wire is extended from the core to the second end portion of the lead in such a manner that the conductor wire is curved to pass the protrusion section. The protrusion section includes an inclined part around which the conductor wire is windable, and which is inclined in such a manner that a protrusion height of the protrusion section decreases in a direction away from the core.

### CROSS-REFERENCE TO RELATED APPLICATIONS

This application is based upon and claims the benefit of priority from Japanese Patent Application No. 2007-329069, filed Dec. 20, 2007, the entire contents of which are incorporated herein by reference.

### BACKGROUND

1. Field

One embodiment of the present invention relates to a coiled component such as a transformer and a coil, and an electronic apparatus provided with the coiled component.

2. Description of the Related Art

A coiled component such as a transformer and the like is mounted on an electronic apparatus such as a portable computer. The coiled component includes a case made of resin, and a core contained in the case.

The core is coiled with a conductor wire. An end portion of the conductor wire is soldered to an end portion of a lead provided on the case. The inside of the case is coated with an adhesive, and the core and a part of the conductor wire are thereby fixed to the inside of the case.

The coiled component is mounted on a printed wiring board in, for example, a reflow process. In this reflow process, the coiled component is heated to a high temperature, and the coiled component expands and contracts with the heat. At this time, the degree of expansion/contraction of the case and the degree of expansion/contraction of the adhesive differ from each other due to the difference in the thermal expansion coefficient. As a result of this, mechanical stress (i.e., tension) is applied to the conductor wire, which leads to a break of the conductor wire in some cases.

In Jpn. Pat. Appln. KOKAI Publication No. 2000-269047, a coil device in which prevention of a wire break at the time of dip processing is intended is disclosed. In this coil device, a rod-like cushion constituted of a thermoplastic resin is provided around a terminal at an insulating base. As the thermoplastic resin, a material that softens to predetermined hardness at an ambient temperature at the time of dip processing is selected. A copper wire extending from a bobbin is integrally wound around the cushion and the terminal.

In Jpn. Pat. Appln. KOKAI Publication No. 10-261526, a molded transformer in which a solution of a problem of a wire break resulting from a drop impact or a heat cycle is devised is disclosed. In this molded transformer, a flange section of a coil bobbin is provided with an engagement projection, the flange section being further provided with a terminal pin implanted therein. A lead wire of the coil is guided to the terminal pin via the projection. This lead wire of the coil is extended via the projection, whereby the lead wire is extended substantially in the horizontal direction with respect to the flow of the molding resin.

By the way, if the conductor wire is broken by the expansion/contraction of the coiled component at the time of a reflow process, the coiled component becomes a defective product, which needs to be replaced. Accordingly, prevention of a break of a conductor wire is desired.

In a coil apparatus described in Jpn. Pat. Appln. KOKAI Publication No. 2000-269047, it is necessary to attach the rod-like cushion constituted of the thermoplastic resin to the insulating base. Further, if the softening of the thermoplastic resin does not sufficiently advance as compared with the mechanical stress applied to the copper wire, there is the possibility of the copper wire being broken.

In the molded transformer described in Jpn. Pat. Appln. KOKAI Publication No. 10-261526, the mold shrinkage factor of the molding resin around the lead wire may become small to a certain degree. However, the mechanical stress is applied to the lead wire all the same. Thus, if the mechanical stress is large, there is the possibility of the lead wire being broken.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view of a portable computer according to a first embodiment of the invention;

FIG. 2 is an exemplary plan view of a coiled component according to the first embodiment of the invention;

FIG. 3 is an exemplary cross-sectional view of the coiled component shown in FIG. 2 taken along line F3-F3;

FIG. 4 is an exemplary cross-sectional view showing a protrusion section shown in FIG. 3 in an enlarging manner;

FIG. 5 is an exemplary plan view showing a state of the coiled component shown in FIG. 2 at the time of a reflow process;

FIG. 6 is an exemplary cross-sectional view showing a state of the coiled component shown in FIG. 5 at the time of a reflow process;

FIG. 7 is an exemplary cross-sectional view showing a first modification example of the protrusion section according to the first embodiment of the present invention;

FIG. 8 is an exemplary cross-sectional view showing a second modification example of the protrusion section according to the first embodiment of the present invention;

FIG. 9 is an exemplary cross-sectional view showing a third modification example of the protrusion section according to the first embodiment of the present invention;

FIG. 10 is an exemplary cross-sectional view of a modification example of the coiled component according to the first embodiment of the present invention; and

FIG. 11 is an exemplary plan view of a coiled component according to a second embodiment of the present invention.

### DETAILED DESCRIPTION

Various embodiments according to the invention will be described hereinafter with reference to the accompanying drawings. In general, according to one embodiment of the invention, a coiled component is provided with (i) a case; (ii) a core contained in the case; (iii) a conductor wire including a portion coiled around the core, and an end portion out of the core; (iV) a lead provided on the case, and including a first end portion, and a second end portion to which the end portion of the conductor wire is connected; and (v) a protrusion section provided on the case, and protruding at a position outwardly shifted from the second end portion of the lead as seen from the core. The conductor wire is extended from the core to the second end portion of the lead in such a manner that the conductor wire is curved to pass the protrusion section. The protrusion section includes an inclined part around which the conductor wire is windable, and which is inclined in such a manner that a protrusion height of the protrusion section decreases in a direction away from the core.

According to one embodiment of the invention, an electronic apparatus is provided with a housing; a printed circuit board contained in the housing; and a coiled component mounted on the printed circuit board. The coiled component is provided with (i) a case; (ii) a core contained in the case; (iii) a conductor wire including a portion coiled around the core, and an end portion out of the core; (iV) a lead provided on the case, and including a first end portion, and a second end portion to which the end portion of the conductor wire is connected; and (v) a protrusion section provided on the case, and protruding at a position outwardly shifted from the second end portion of the lead as seen from the core. The conductor wire is extended from the core to the second end portion of the lead in such a manner that the conductor wire is curved to pass the protrusion section. The protrusion section includes an inclined part around which the conductor wire is windable, and which is inclined in such a manner that a protrusion height of the protrusion section decreases in a direction away from the core.

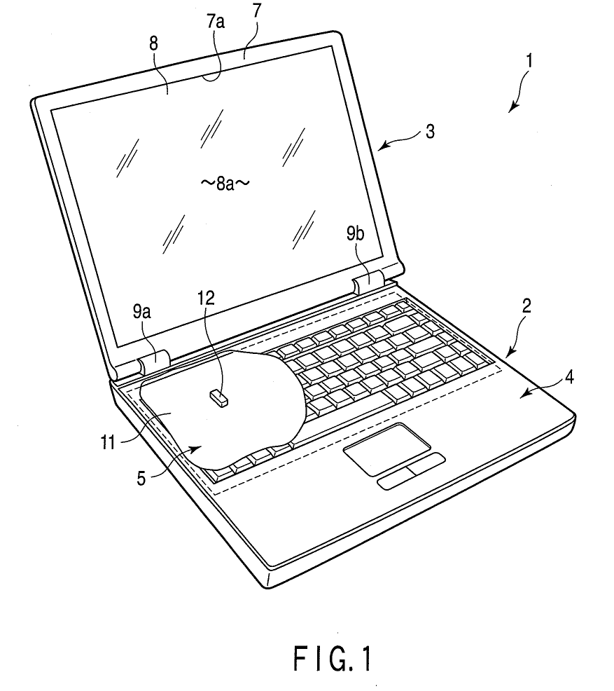

An example in which an embodiment of the present invention is applied to a coiled component to be mounted on a portable computer will be described below on the basis of the accompanying drawings. FIGS. 1 to 10 disclose a portable computer 1 as an electronic apparatus according to a first embodiment of the present embodiment, and a coiled component 12. As shown in FIG. 1, the portable computer 1 includes a main body 2 and a display unit 3.

The main body 2 includes a housing 4 formed into a box-like shape. The housing 4 contains a printed circuit board 5. The display unit 3 includes a display housing 7, and a display device 8 contained in the display housing 7. The display device 8 includes a display screen 8a. The display screen 8a is exposed to the outside of the display housing 7 through an opening part 7a in the front of the display housing 7. The display unit 3 is supported on a rear end part of the housing 4 through a pair of hinge sections 9a and 9b.

As shown in FIG. 1, the printed circuit board 5 includes a printed wiring board 11, and various electronic components mounted on the printed wiring board 11. One of the electronic components is a coiled component 12. Examples of the coiled component 12 are, for example, a transformer, coil, filter (for example, a common mode filter), and the like. Incidentally, the coiled component mentioned in the present invention is not limited to the examples.

Next, an example of the coiled component 12 will be described below in detail. Incidentally, as the example of the coiled component 12 to be described below, that having a simple configuration is taken up for convenience of explanation. Incidentally, the present invention is not limited to the coiled component having the simple configuration, and is applicable to various coiled components provided with a plurality of cores, and many leads corresponding to the cores.

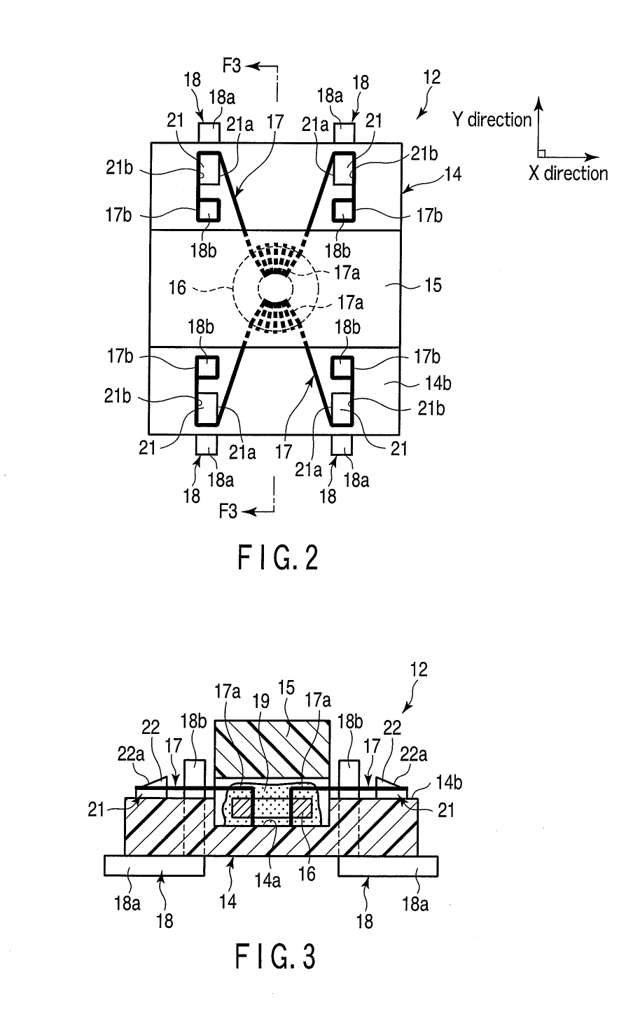

As shown in FIGS. 2 and 3, a coiled component 12 as an example is provided with a case 14 (i.e., a mold), cover 15, core 16, conductor wire 17, and lead 18.

The case 14 is made of, for example, a synthetic resin. As shown in FIG. 3, the case 14 is provided with a concave part inside the case 14, and a containing section 14a for containing the core 16 is formed by the concave part. The containing section 14a is provided at, for example, a central part of the case 14. A cover 15 for covering the containing section 14a is attached to the case 14.

The core 16 is a member serving as a path of the magnetic flux, and is, for example, an iron core. As shown in FIG. 2, the core 16 is formed into, for example, a toroidal shape, and, for example, two conductor wires are coiled around it. The core 16 is contained in the containing section 14a in a state where the conductor wires 17 are coiled around it.

The conductor wire 17 is, for example, a copper wire, an iron wire, and the like. Incidentally, the conductor wire 17 is not limited to the above examples, and the type thereof is arbitrary as long as the wire 17 is formed of a material for passing an electric current therethrough. As shown in FIG. 2, the conductor wire 17 includes a portion 17a (for example, a central portion) coiled around the core 16, and two end portions 17b out of the core 16.

As shown in FIG. 3, an adhesive 19 is applied to the inside of the containing section 14a of the case 14. The core 16, and a part of each conductor wire 17 coiled around the core 16 are fixed to the inside of the case 14 by means of the adhesive 19.

As shown in FIG. 2, a plurality of leads 18 are provided. As shown in FIG. 3, each of the leads 18 is provided on the case 14, and includes first and second end portions 18a and 18b each protruding to the outside of the case 14. The first end portion 18a is an end portion to be soldered to a pad (not shown) provided on the printed wiring board 11, and to be electrically connected to the printed wiring board 11. As shown in FIG. 2, when viewed from the core 16, the first end portion 18a extends outwardly from the peripheral edge of the case 14.

As shown in FIG. 2, the second end portion 18b of the lead 18 is an end portion to which the end portion 17b of the conductor wire 17 is connected. The end portion 17b of the conductor wire 17 is connected to the second end portion 18b of the lead 18 by, for example, soldering. The second end portion 18b of the lead 18 is positioned closer to the containing section 14a than the first end portion 18a. As shown in FIG. 3, the second end portion 18b protrudes from one case surface 14b of the case 14, and the end portion 17b of the conductor wire 17 is windable around the end portion 18b. The second end portion 18b is electrically connected to the first end portion 18a.

As shown in FIG. 2, the case 14 is provided with protrusion sections 21 of the same number as the number of, for example, the leads 18. When viewed from the core 16 (i.e., as seen from the core 16), the protrusion section 21 protrudes at a position outwardly (i.e., to the peripheral edge side of the case 14) shifted from the second end portion 18b of the lead 18.

As shown in FIG. 3, the protrusion section 21 is provided on the case surface 14b from which the second end portion 18b of the lead 18 protrudes, and protrudes in the same direction as the second end portion 18b of the lead 18. The protrusion section 21 is, for example, an additional mold. That is, the protrusion section 21 is made of the same material as the case 14 and formed integral with the case 14.

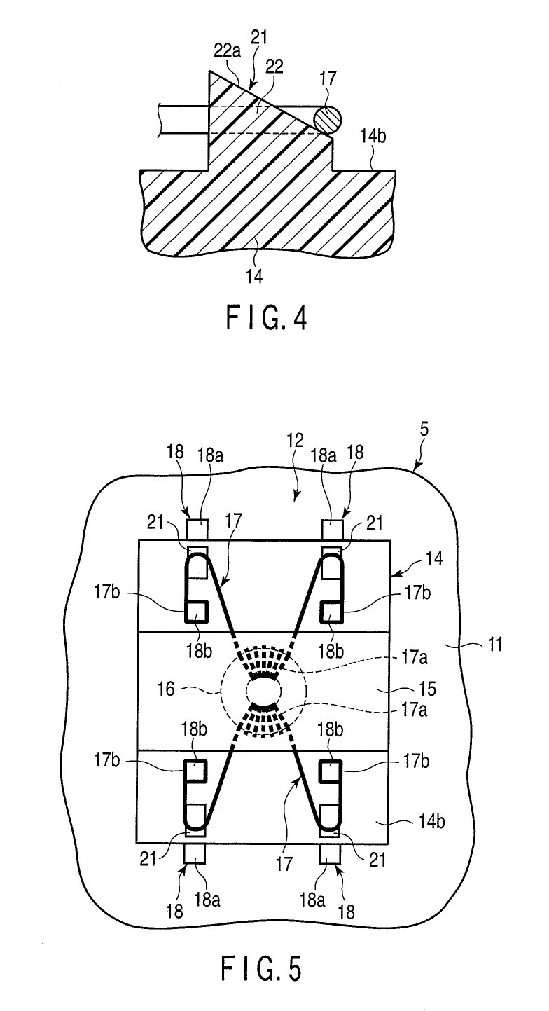

As shown in FIGS. 3 and 4, the protrusion section 21 includes an inclined part 22 around which the conductor wire 17 is windable. The inclined part 22 is provided at, for example, a distal end part of the protrusion section 21, and is inclined in such a manner that a protrusion height (i.e., a height from the case surface 14b) of the protrusion section 21 decreases in a direction away from the core 16. In other words, the distal end part of the protrusion section 21 is cut obliquely at the outside part as seen from the core 16. The inclined part 22 includes an inclined surface 22a around which the conductor wire 17 is windable. The inclined surface 22a according to this embodiment is formed flat.

As shown in FIG. 2, the conductor wire 17 is extended from the core 16 to the second end portion 18b of the lead 18 in such a manner that the conductor wire 17 is curved to pass the protrusion section 21. The conductor wire 17 is, for example, extended from the core 16 to the second end portion 18b of the lead 18 via the protrusion section 21 in a curving manner. The conductor wire 17 is wound around the inclined surface 22a of the protrusion section 21 for example, substantially halfway around the protrusion section 21 from the outside as seen from the core 16.

The plural leads 18 provided on one side of the core 16 are arranged side by side with each other in one direction (X direction in FIG. 2). The plural protrusion sections 21 correspond to the plural leads 18 on a one-to-one basis. The protrusion section 21 is arranged side by side with the second end portion 18b of the corresponding lead 18 (i.e., the second end portion 18b of one of the leads 18) in the direction (Y direction in FIG. 2) perpendicular to the direction (X direction in FIG. 2) in which the plural leads 18 described above are arranged.

As shown in FIG. 2, in the direction (X direction) in which the plural leads 18 are arranged, the protrusion section 21 includes a first side surface 21a opposed to another protrusion section 21 corresponding to the same core 16 as the protrusion section 21, and a second side surface 21b on the opposite side of the first side surface 21a. The conductor wire 17 extending from the core 16 first extends along the first side surface 21a, and is then wound around the protrusion section 21 to detour to the second side surface 21b.

Next, an example of a method of manufacturing the coiled component 12 will be described below.

First, the case 14 with which the protrusion sections 21 are formed integral, and the core 16 around which the conductor wires 17 are coiled are prepared. The case 14 is provided with the leads 18. Further, the core 16 around which the conductor wires 17 are coiled is put into the containing section 14a of the case 14.

After the core 16 is put into the case 14, the work for connecting each of the end portions 17b of the conductor wires 17 to the second end portion 18b of each of the leads 18 is performed. This work is manually performed by using, for example, tweezers or the like. Specifically, as shown in FIG. 2, the conductor wire 17 is first drawn out to the vicinity of the protrusion section 21, and the drawn-out conductor wire 17 is wound around the inclined surface 22a of the protrusion section 21.

Then, tension is applied to the conductor wire 17 by using the protrusion section 21 as a fulcrum. That is, in a state where the conductor wire 17 is tensioned between the protrusion section 21 and the end portion 17b of the conductor wire 17, the end portion 17b of the conductor wire 17 is wound around the second end portion 18b of the lead 18. After the conductor wire 17 is wound around the second end portion 18b of the lead 18, the conductor wire 17 is fixed to the second end portion 18b of the lead 18 by soldering.

On the other hand, before, after, or simultaneously with the connection of the conductor wire 17 to the second end portion 18b of the lead 18, the adhesive 19 is applied to the inside of the containing section 14a of the case 14, and the core 16 is thereby fixed to the case 14. Finally, the cover 15 is attached to the case 14, whereby the assembly of the coiled component 12 is completed in a general way.

Next, the function of the coiled component 12 will be described below.

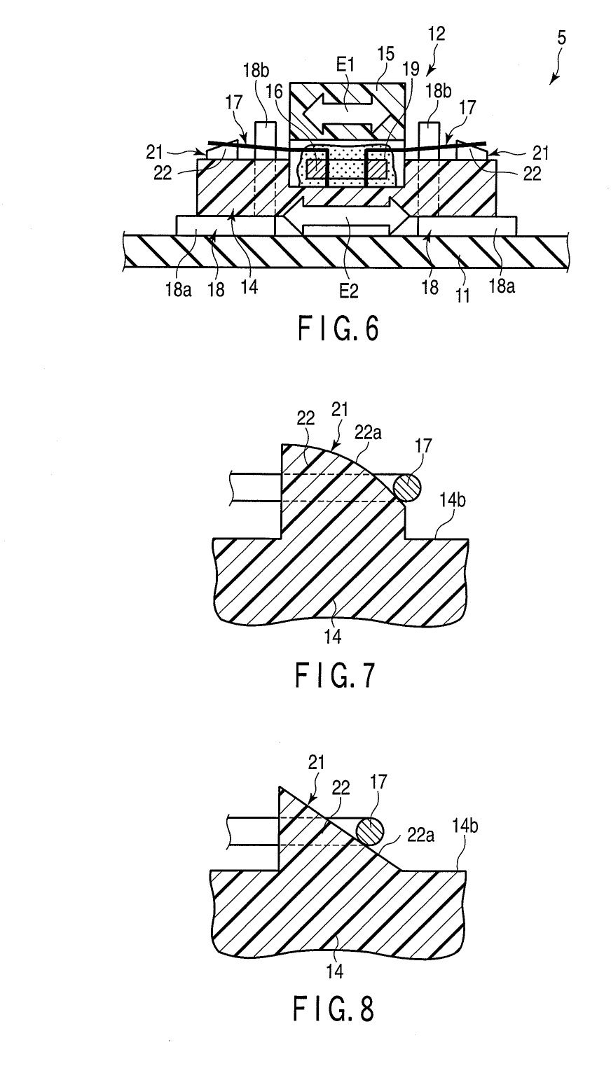

The coiled component 12 is mounted on the printed wiring board 11 in a reflow process. At the time of the reflow process, the coiled component 12 is heated at a high temperature, and the coiled component expands and contracts with the heat. Here, the thermal expansion coefficient of the case 14 made of the synthetic resin is larger than that of the adhesive 19. Accordingly, at the time of thermal expansion of the coiled component 12, the expansion E2 of the case 14 is grater than the expansion E1 of the adhesive 19 (see FIG. 6). As a result of this, mechanical stress, i.e., tension is applied to the conductor wire 17 between the core 16 and the second end portion 18b of the lead 18.

If the tension becomes large to a certain degree, as shown in FIGS. 5 and 6, the conductor wire 17 wound around the inclined surface 22a is slid to be moved along the inclined surface 22a, and the conductor wire 17 is naturally released from the protrusion section 21. As a result of this, a bent part extended to be curved is caused on the conductor wire 17 between the core 16 and the second end portion 18b of the lead 18, and the mechanical stress exerted on the conductor wire 17 is relieved.

According to the coiled component 12 configured as described above, it is possible to contrive wire break prevention of the conductor wire 17 by a simple configuration.

First, in the case where the case 14 is provided with the protrusion section 21 protruding at a position outwardly shifted from the second end portion 18b, the workability of the work for connecting the end portion 17b of the conductor wire 17 to the second end portion 18b of the lead 18 improves. That is, by winding the conductor wire 17 about the protrusion section 21, it is possible to wind the end portion 17b of the conductor wire 17 around the second end portion 18b while applying tension to the conductor wire 17. When the work can be performed in the state where the conductor wire 17 is tensioned, it is easy to wind the conductor wire 17 around the second end portion 18b, and the workability of the work improves.

In the case where the conductor wire 17 is provided with the inclined part 22 around which the conductor wire 17 is windable, and the inclined part 22 is inclined in such a manner that a protrusion height of the protrusion section 21 decreases in a direction away from the core 16, if the tension exerted on the conductor wire 17 becomes large to a certain degree, the conductor wire 17 wound around the inclined surface 22a of the protrusion section 21 is slid to be moved along the inclined surface 22a by the tension, and the conductor wire 17 is naturally released from the protrusion section 21.

That is, tension is hardly exerted excessively on the conductor wire 17 even when the coiled component 12 is expanded. As a result of this, in the coiled component 12, it is possible to contrive wire break prevention of the conductor wire 17. When it is possible to contrive wire break prevention of the conductor wire 17, the percent defective of the coiled component 12 may be reduced, and the labor and cost necessary for replacement of the defective component become smaller, which leads to improvement in productivity and maintainability.

As described above, the coiled component 12 according to this embodiment is provided with the protrusion section 21 with an inclined part 22 as a mechanism for relieving excessive tension exerted on the conductor wire 17. When it is possible to contrive wire break prevention of the conductor wire 17 by such a simple configuration, it is easily possible to configure the structure of the coiled component 12 in a relatively simple manner, and prevent the manufacturing cost from being increased.

In the coiled component 12 according to this embodiment, the mechanism for relieving the tension exerted on the conductor wire 17 is constituted only of the shape of the protrusion section 21. Accordingly, when the tension is exerted on the conductor wire 17 to a certain degree, the conductor wire 17 is naturally released from the protrusion section 21 by the tension without being affected by the external environment (for example, temperature). That is, it may be said that the mechanism according to this embodiment operates stably and securely as compared with a mechanism depending on the external environment (for example, a mechanism using a thermoplastic resin).

When the protrusion section 21 is made of the same material as the case 14 and formed integral with the case 14, a process of preparing the protrusion section 21 separately from the case 14, a process of attaching the protrusion section 21 to the case 14, and the like are made unnecessary. That is, in the coiled component 12 according to this embodiment, it is possible to realize high manufacturability.

When the protrusion section 21 is protruded from the case 14 in the same direction as the second end portion 18b of the lead 18, it becomes easy to perform the work for winding the conductor wire 17 about the protrusion section 21, and connecting the conductor wire 17 to the second end portion 18b. When the inclined part 22 includes an inclined surface 22a formed into a flat surface, it becomes easier to form the inclined part 22 than the case where the inclined part 22 is formed into, for example, a curved surface.

When the protrusion section 21 is arranged side by side with the second end portion 18b of the lead 18 in the direction perpendicular to the direction in which the plural leads are arranged side by side with each other, it is easy to secure a distance between each part of the conductor wire 17 to be connected to each lead 18, and it is possible to contrive reduction in size of the coiled component 12. When the distance between each part of the conductor wire 17 to be connected to each lead 18 is secured to a certain degree, it is easy to improve the workability of the work for arranging the conductor wires 17 and the like.

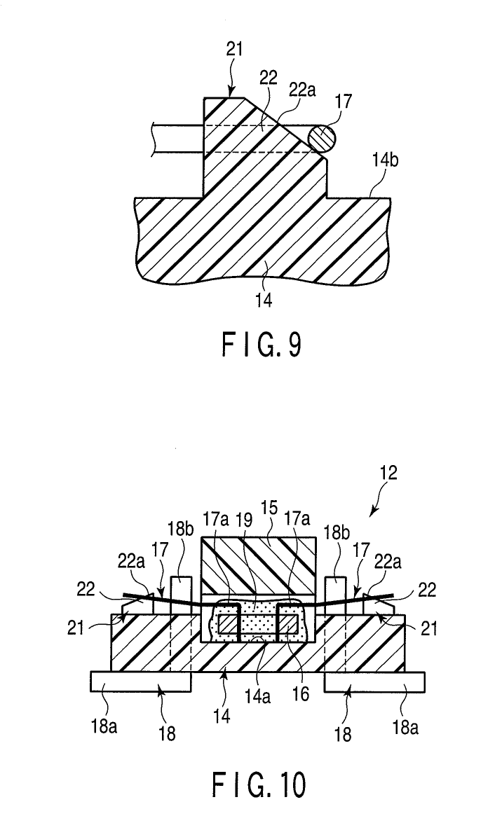

Next, various modification examples of the protrusion section 21 will be shown with reference to FIGS. 7 to 9. As shown in FIG. 7, the inclined surface 22a of the protrusion section 21 may be formed into a curved surface. As shown in FIG. 8, the inclined part 22 of the protrusion section 21 may be provided over the entire protrusion height of the protrusion section 21. As shown in FIG. 9, the inclined part 22 may be provided at a part of the distal end part of the protrusion section 21.

FIG. 10 shows one of modification examples of the coiled component 12. In this coiled component 12, at the step prior to being mounted on the printed wiring board 11, the conductor wire 17 is already released from the protrusion section 21. The expression “the conductor wire is extended from the core to the second end portion of the lead in such a manner that the conductor wire is curved to pass the protrusion section” mentioned in the present invention also includes the case where the conductor wire 17 is off the protrusion section 21 in addition to the case where the conductor wire 17 is wound around the protrusion section 21.

That is, in the coiled component 12, after the end portion 17b of the conductor wire 17 is connected to the second end portion 18b of the lead 18 by utilizing the protrusion section 21 (that is, by winding the conductor wire 17 about the protrusion section 21), the conductor wire 17 may be artificially or naturally released from the protrusion section 21. With such a coiled component 12, it is possible to prevent excessive tension from being exerted on the conductor wire 17, and contrive wire break prevention of the conductor wire 17.

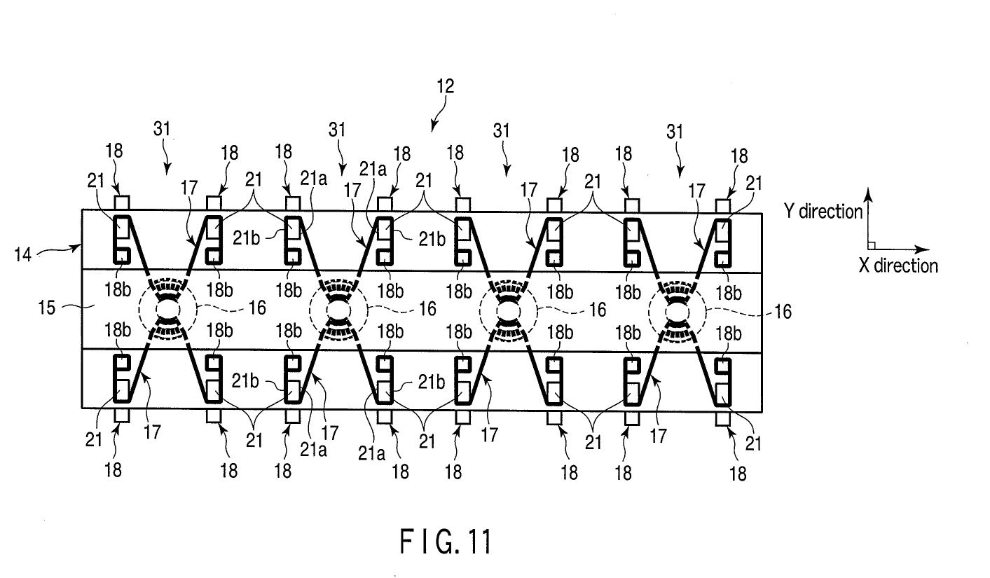

Next, a coiled component 12 according to a second embodiment of the present invention will be described below with reference to FIG. 11. Incidentally, a configuration provided with a function identical with or similar to that of the first embodiment is denoted by the identical reference symbol, and a description thereof is omitted. The coiled component 12 according to this embodiment is mounted on, for example, a portable computer 1 which is an electronic apparatus identical with that of the first embodiment.

As shown in FIG. 11, in the coiled component 12 according to this embodiment, a plurality of functional units 31 are provided in array in one direction (X direction in FIG. 11). Each functional unit 31 includes, for example, a core 16, conductor wires 17, and leads 18.

A plurality of leads 18 are provided in array in the X direction in FIG. 11. A plurality of protrusion sections 21 correspond to the plural leads 18 on a one-to-one basis. The protrusion section 21 is arranged side by side with a second end portion 18b of a lead 18 to which the protrusion section 21 corresponds in a direction (Y direction in FIG. 11) perpendicular to the direction (X direction in FIG. 11) in which the plural leads 18 are arranged side by side each other. The configuration of the coiled component 12 other than that described above is identical with the first embodiment described above.

According to the coiled component 12 configured as described above, it is possible to contrive wire break prevention of the conductor wire 17 by a simple configuration as in the first embodiment.

When the protrusion section 21 is arranged side by side with the second end portion 18b of the lead 18 to which the protrusion section 21 corresponds in the direction perpendicular to the direction in which the plural functional units 31 are arrayed, it is possible to contrive reduction in size of the coiled component 12 while securing a distance between each part of the conductor wire 17 to be connected to each lead 18 as compared with a case where the protrusion sections 21 are provided between the plural functional units 31.

The coiled component 12 and the portable computer 1 according to each of the first and second embodiments have been described above. However, the present invention is not limited to those. For example, in the coiled component 12 according to the second embodiment, the same structures as the modification examples shown in FIGS. 7 to 10 can be applied thereto.

The protrusion section 21 is not necessarily arranged side by side with the second end portion 18b of the corresponding lead 18 in the direction perpendicular to the direction in which the plural leads are arrayed side by side with each other. The protrusion section 21 is not necessarily made of the same material as the case 14.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A coiled component comprising:
a case;
a core in the case;
a conductor wire comprising a portion coiled around the core, and an end portion out of the core;
a lead on the case, comprising a first end portion, and a second end portion configured to connect to the end portion of the conductor wire; and
a protruding portion on the case, protruding at a position externally from the second end portion of the lead with respect to the core, wherein
the conductor wire is extending from the core to the second end portion of the lead in such a manner that the conductor wire is curved to pass the protrusion section, and
the protrusion section comprising a slope around which the conductor wire can be twined, and a height of the protruding portion decreases as a distance from the core increases.

2. The coiled component of claim 1, wherein
the protruding portion is made of the same material as the case, and formed integral with the case.

3. The coiled component of claim 1, wherein
the second end portion of the lead is configured to protrude to an outside of the case, and
the protruding portion is configured protrude from the case in the same direction as the second end portion of the lead.

4. The coiled component of claim 1, wherein
the slope comprises a flat surface.

5. The coiled component of claim 1, further comprising a plurality of leads among which the lead is comprised, wherein
the plural leads are arranged next to each other on the case, and
the protruding portion is arranged next to the second end portion of one of the leads in a direction perpendicular to a direction in which the plural leads are arranged side by side with each other.

6. An electronic apparatus comprising:
a housing;
a printed circuit board in the housing; and
a coiled component on the printed circuit board, wherein
the coiled component comprises
a case;
a core contained in the case;
a conductor wire comprising a portion coiled around the core, and an end portion out of the core;
a lead on the case, and comprising a first end portion, and a second end portion to which the end portion of the conductor wire is connected; and
a protruding portion provided on the case, and protruding at a position externally from the second end portion of the lead with respect to the core,
the conductor wire is extended from the core to the second end portion of the lead in such a manner that the conductor wire is curved to pass the protruding portion, and
the protruding portion comprises a slope around which the conductor wire is twined, and a height of the protruding portion decreases as a distance from the core increases.
